(19) United States
(12) Patent Application Publication
(10) Pub. No.: US 2022/0235865 A1
(43) Pub. Date: Jul. 28, 2022

(54) GATE VALVE ARRANGEMENT

(71) Applicant: Allegheny Valve & Coupling, Inc., Warren, PA (US)

(72) Inventor: Raymond V. Heelan, JR., Warren, PA (US)

(21) Appl. No.: 17/579,824

(22) Filed: Jan. 20, 2022

Related U.S. Application Data
(60) Provisional application No. 63/140,509, filed on Jan. 22, 2021.

(51) Int. Cl. F16K 1/24; F16K 31/528

(52) U.S. Cl. CPC F16K 1/24; F16K 31/5282

(57) ABSTRACT

A valve arrangement includes a valve body having a stem rotatably attached at least partially within the body, a handle in operable communication with the stem and configured to rotate the stem by turning the handle, and an actuation portion in contact with the stem and configured to move when the handle is turned and the stem rotated. The actuation portion includes a carrier having an inner bore. The inner bore receives at least a portion of the stem. The stem includes first and second thread portions. The first thread portion has a first thread pitch at least partially received within the inner bore. The second thread portion is in communication with a bonnet attached to the body with a second thread pitch and moves the stem with respect to the body. The second pitch is smaller than the first pitch.

### CROSS-REFERENCE TO RELATED APPLICATION

This application claims priority to U.S. Provisional Patent Application No. 63/140,509, filed Jan. 22, 2021, the disclosure of which is incorporated by reference herein in its entirety.

### BACKGROUND

### Technical Field

The present disclosure relates generally to valves and valving arrangements for interacting with various components of a material transfer or handling system, such as a pipeline in a loading or unloading application and, in particular, to a valve arrangement that allows for quick opening, quick closure, more powerful “seating” of the actuation portion of the valve, and a smaller package.

### Technical Considerations

Valves are used in a variety of applications and systems that require the prevention, redirection, or manipulation of various product and material streams, whether solid, semi-solid, or fluid materials. As is known in the art, these materials flow through the material handling system, such as in pipelines and the like, in order to transfer the materials from one location to another. In order to manage the direction, flow, and other characteristics of the material transfer process, valve arrangements are utilized. For example, such valve arrangements may include gate valves, manifold valves, butterfly valves, flapper valves, etc.

With respect to these valve arrangements, it is desirous to provide for the quick opening and closure of such a valve for a variety of safety reasons. For example, in the instance of a pipeline failure in an upstream portion of the pipeline, a downstream valve, such as a gate valve, must be quickly closed to prevent any further fluid communication of the product. Accordingly, not only is the speed of closure important, but the valve must also be “seated” or sealed appropriately using the actuation portion (e.g., the gate). Therefore, not only must the person quickly close or open the valve in certain situations, but the valve must also provide the optimum sealing characteristics in order to ensure that no material moves through the actuation portion when it is in the closed position.

Another safety consideration with respect to valving arrangements is the position of the handle and stem with respect to the walkway or passageway adjacent the handle. For example, and according to the prior art, most valve stems and handles project from the valve and pipe and extend into the walkway, which may pose a safety risk. In addition, many such piping systems include very narrow passageways, such that the projection or extension of the valve stem and handle into these passageways must be minimized as much as possible.

### SUMMARY

In some non-limiting embodiments or aspects, a valve arrangement is provided that allows for a faster opening and closure of the actuation portion of the valve. The valve arrangement also provides for a more effective and powerful seating of the actuation portion when the valve is in a closed position and minimizes the projection of the stem and handle whether the valve is in the “open” or “closed” position.

In some non-limiting embodiments or aspects, a valve arrangement is provided. The valve arrangement may include a valve body having a stem rotatably attached at least partially within the body, a handle in operable communication with the stem and configured to rotate the stem by a turning movement, and an actuation portion in contact with the stem and configured to move when the handle is turned and the stem rotated. The stem may include a first thread portion having a first thread pitch and a second thread portion having a second thread pitch smaller than the first thread pitch. The actuation portion may include a carrier having an inner bore and two discs mounted onto the carrier, wherein the inner bore is configured to receive at least a portion of the stem and the two steel discs are configured to block fluid flowing through a pipe. At least a portion of the first thread portion may be configured to be at least partially received within the inner bore in order to interact with and move the carrier, and the second thread portion may be configured to be at least partially received within a bonnet attached to the valve body and configured to move the stem with respect to the valve body.

In some non-limiting embodiments or aspects, the first thread portion may include a double-start or triple-start thread. A ratio of the second thread portion relative to the first thread portion may be between 2:1 and 3:1.

In some non-limiting embodiments or aspects, the handle is attached to the stem with an attachment nut which interacts with a third thread portion of the stem.

In some non-limiting embodiments or aspects, each of the two discs may be a Bellevile disc that is connected to the carrier. The two discs may be angled in opposite directions relative to the stem such that a distance between bottom portions of each disc is smaller than a distance between top portions of each disc.

In some non-limiting embodiments or aspects, the valve body may include a first body half connected to a second body half. Each of the first body half and the second body half may include a pipe portion. The first body half and the second body half may define a valve seat below the pipe portions, and the valve seat may be configured to receive at least a portion of the actuation portion. The first body half and the second body half may define a sleeve configured for receiving the bonnet. The carrier may include a hollow interior defining an inner bore configured for receiving the first thread portion.

In some non-limiting embodiments or aspects, a valve arrangement may include a valve body having a stem rotatably attached at least partially within the body, a handle in operable communication with the stem and configured to rotate the stem by a turning movement, and an actuation portion in contact with the stem and configured to move when the handle is turned and the stem rotated. The stem may include a first thread portion having a first thread pitch and a second thread portion having a second thread pitch smaller than the first thread pitch.

In some non-limiting embodiments or aspects, the actuation portion may include a carrier having an inner bore and two discs mounted onto the carrier, and the inner bore may be configured to receive at least a portion of the stem and the two steel discs are configured to block fluid flowing through a pipe.

In some non-limiting embodiments or aspects, at least a portion of the first thread portion may be configured to be at least partially received within the inner bore in order to interact with and move the carrier, and the second thread portion may be configured to be at least partially received within a bonnet attached to the valve body and configured to move the stem with respect to the valve body.

In some non-limiting embodiments or aspects, the first thread portion may include a double-start or triple-start thread. A ratio of the second thread portion relative to the first thread portion may be between 2:1 and 3:1.

In some non-limiting embodiments or aspects, each of the two discs maybe a Bellevile disc that is connected to the carrier. The two discs may be angled in opposite directions relative to the stem such that a distance between bottom portions of each disc is smaller than a distance between top portions of each disc.

In some non-limiting embodiments or aspects, the valve body may include a first body half connected to a second body half, and each of the first body half and the second body half may include a pipe portion.

In some non-limiting embodiments or aspects, the first body half and the second body half may define a valve seat below the pipe portions, and the valve seat may be configured to receive at least a portion of the actuation portion. The first body half and the second body half may define a sleeve configured for receiving the bonnet.

Further non-limiting embodiments or aspects are set forth in the following numbered clauses:

Clause 1. A valve arrangement, comprising: a valve body having a stem rotatably attached at least partially within the body; a handle in operable communication with the stem and configured to rotate the stem by a turning movement; and an actuation portion in contact with the stem and configured to move when the handle is turned and the stem rotated, wherein the stem comprises a first thread portion having a first thread pitch and a second thread portion having a second thread pitch smaller than the first thread pitch, wherein the actuation portion comprises a carrier having an inner bore and two discs mounted onto the carrier, wherein the inner bore is configured to receive at least a portion of the stem and the two steel discs are configured to block fluid flowing through a pipe, wherein at least a portion of the first thread portion is configured to be at least partially received within the inner bore in order to interact with and move the carrier, and the second thread portion is configured to be at least partially received within a bonnet attached to the valve body and configured to move the stem with respect to the valve body

Clause 2. The valve arrangement of clause 1, wherein the first thread portion comprises a double-start or triple-start thread.

Clause 3. The valve arrangement of clause 1 or 2, wherein a ratio of the second thread portion relative to the first thread portion is between 2:1 and 3:1.

Clause 4. The valve arrangement of any of clauses 1-3, wherein the handle is attached to the stem with an attachment nut which interacts with a third thread portion of the stem.

Clause 5. The valve arrangement of any of clauses 1-4, wherein each of the two discs is a Bellevile disc that is connected to the carrier.

Clause 6. The valve arrangement of any of clauses 1-5, wherein the two discs are angled in opposite directions relative to the stem such that a distance between bottom portions of each disc is smaller than a distance between top portions of each disc.

Clause 7. The valve arrangement of any of clauses 1-6, wherein the valve body comprises a first body half connected to a second body half.

Clause 8. The valve arrangement of any of clauses 1-7, wherein each of the first body half and the second body half comprises a pipe portion.

Clause 9. The valve arrangement of any of clauses 1-8, wherein the first body half and the second body half define a valve seat below the pipe portions, and wherein the valve seat is configured to receive at least a portion of the actuation portion.

Clause 10. The valve arrangement of any of clauses 1-9, wherein the first body half and the second body half define a sleeve configured for receiving the bonnet.

Clause 11. The valve arrangement of any of clauses 1-10, wherein the carrier comprises a hollow interior defining an inner bore configured for receiving the first thread portion.

Clause 12. A valve arrangement, comprising: a valve body having a stem rotatably attached at least partially within the body; a handle in operable communication with the stem and configured to rotate the stem by a turning movement; and an actuation portion in contact with the stem and configured to move when the handle is turned and the stem rotated, wherein the stem comprises a first thread portion having a first thread pitch and a second thread portion having a second thread pitch smaller than the first thread pitch.

Clause 13. The valve arrangement of clause 12, wherein the actuation portion comprises a carrier having an inner bore and two discs mounted onto the carrier, and wherein the inner bore is configured to receive at least a portion of the stem and the two steel discs are configured to block fluid flowing through a pipe.

Clause 14. The valve arrangement of clause 12 or clause 13, wherein at least a portion of the first thread portion is configured to be at least partially received within the inner bore in order to interact with and move the carrier, and the second thread portion is configured to be at least partially received within a bonnet attached to the valve body and configured to move the stem with respect to the valve body.

Clause 15. The valve arrangement of any of clauses 12-14, wherein the first thread portion comprises a double-start or triple-start thread.

Clause 16. The valve arrangement of any of clauses 12-15, wherein a ratio of the second thread portion relative to the first thread portion is between 2:1 and 3:1.

Clause 17. The valve arrangement of any of clauses 12-16, wherein each of the two discs is a Bellevile disc that is connected to the carrier, and wherein the two discs are angled in opposite directions relative to the stem such that a distance between bottom portions of each disc is smaller than a distance between top portions of each disc.

Clause 18. The valve arrangement of any of clauses 12-17, wherein the valve body comprises a first body half connected to a second body half, and wherein each of the first body half and the second body half comprises a pipe portion.

Clause 19. The valve arrangement of any of clauses 12-18, wherein the first body half and the second body half define a valve seat below the pipe portions, and wherein the valve seat is configured to receive at least a portion of the actuation portion.

Clause 20. The valve arrangement of any of clauses 12-19, wherein the first body half and the second body half define a sleeve configured for receiving the bonnet.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure.

### BRIEF DESCRIPTION OF THE DRAWINGS

FIG. 1 is a front view of a valve arrangement according to some non-limiting embodiments or aspects of the present disclosure;

FIG. 2 is a cross-sectional view of the valve arrangement of FIG. 1 with a partial cross-sectional view of the stem of the valve arrangement along line A-A; and

FIG. 3 is a side view of a stem and a nut of the valve arrangement according to some non-limiting embodiments or aspects of the present disclosure.

### DETAILED DESCRIPTION

As used herein, the singular form of “a”, “an”, and “the” include plural referents unless the context clearly dictates otherwise. Spatial or directional terms, such as “left”, “right”, “inner”, “outer”, “above”, “below”, and the like, relate to the embodiments or aspects as shown in the drawing figures and are not to be considered as limiting as the embodiments or aspects can assume various alternative orientations. All numbers used in the specification and claims are to be understood as being modified in all instances by the term “about” or “approximately”. By “about” or “approximately” is meant within plus or minus twenty-five percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or subratios subsumed therein. For example, a stated range or ratio of “1 to 10” should be considered to include any and all subranges or subratios between (and inclusive of) the minimum value of 1 and the maximum value of 10; that is, all subranges or subratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements. All documents referred to herein are “incorporated by reference” in their entirety. The term “at least” is synonymous with “greater than or equal to”.

As used herein, “at least one of” is synonymous with “one or more of”. For example, the phrase “at least one of A, B, or C” means any one of A, B, or C, or any combination of any two or more of A, B, or C. For example, “at least one of A, B, and C” includes A alone; or B alone; or C alone; or A and B; or A and C; or B and C; or all of A, B, and C. The word “comprising” and “comprises”, and the like, does not exclude the presence of elements or steps other than those listed in any claim or the specification as a whole. In the present specification, “comprises” means “includes” and “comprising” means “including”.

As used herein, the terms “parallel” or “substantially parallel” mean a relative angle as between two objects (if extended to theoretical intersection), such as elongated objects and including reference lines, that is from 0° to 5°, or from 0° to 3°, or from 0° to 2°, or from 0° to 1°, or from 0° to 0.5°, or from 0° to 0.25°, or from 0° to 0.1°, inclusive of the recited values. As used herein, the terms “perpendicular”, “transverse”, “substantially perpendicular”, or “substantially transverse” mean a relative angle as between two objects at their real or theoretical intersection is from 85° to 90°, or from 87° to 90°, or from 88° to 90°, or from 89° to 90°, or from 89.5° to 90°, or from 89.75° to 90°, or from 89.9° to 90°, inclusive of the recited values.

The discussion of various embodiments or aspects may describe certain features as being “particularly” or “preferably” within certain limitations (e.g., “preferably”, “more preferably”, or “even more preferably”, within certain limitations). It is to be understood that the disclosure is not limited to these particular or preferred limitations but encompasses the entire scope of the various embodiments and aspects described herein. The disclosure comprises, consists of, or consists essentially of, the following embodiments or aspects, in any combination. Various embodiments or aspects of the disclosure are illustrated in separate drawing figures. However, it is to be understood that this is simply for ease of illustration and discussion. In the practice of the disclosure, one or more embodiments or aspects shown in one drawing figure can be combined with one or more embodiments or aspects shown in one or more of the other drawing figures.

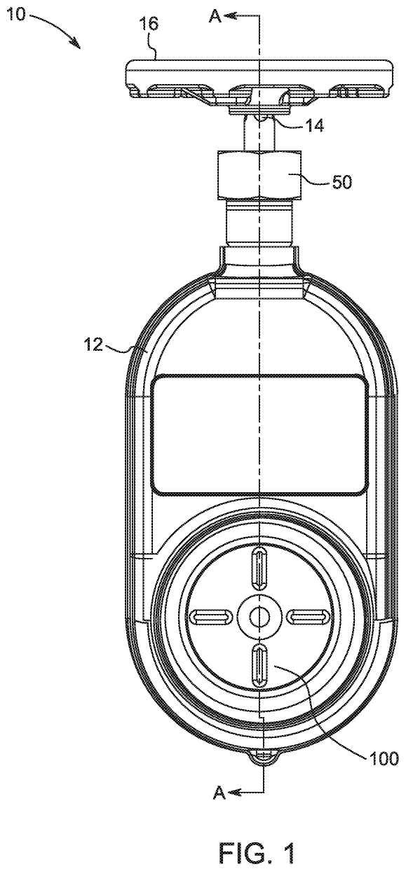

The present disclosure is directed to a valve arrangement 10 as illustrated in the non-limiting embodiments or aspects shown in FIGS. 1-3. It should be noted that the embodiments or aspects illustrated herein include components and subcomponents that are typical structural and operational components of a gate valve. The use of the gate valve as one example of the present disclosure is intended to be in no way limiting to the use of this arrangement and operation in connection with other valve types.

In some non-limiting embodiments or aspects, and with initial reference to FIG. 1, the valve arrangement 10 includes a valve body 12. A stem 14 extends at least partially within the valve body 12 and is rotatable within the valve body 12. A handle 16 is in operable communication with or attached to the stem 14. In operation, when the handle 16 is turned, the stem 14 rotates within the body 12.

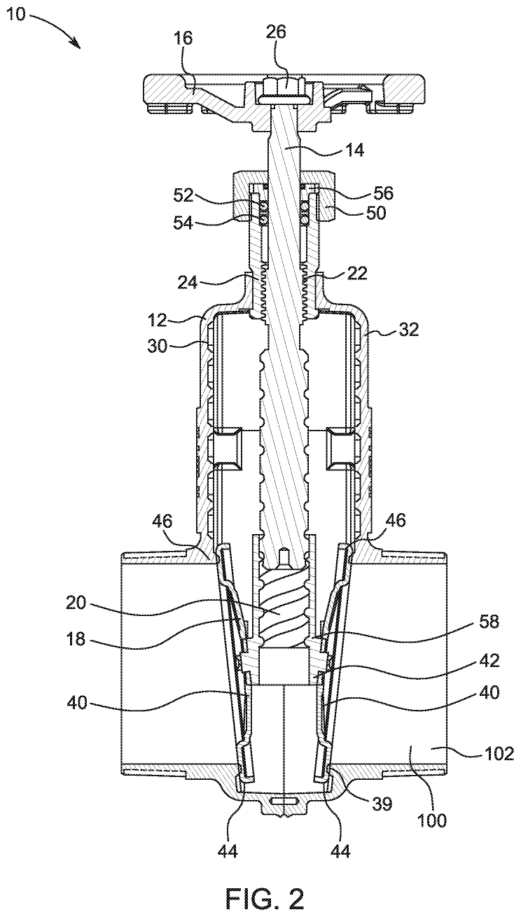

With reference to FIG. 2, an actuation portion 18 is in direct or indirect contact with the stem 14. Through this contact, the actuation portion 18 is configured to move when the handle 16 is turned and the stem 14 rotated. It is contemplated that the stem 14 may be made of stainless steel or other materials known to be suitable to those having skill in the art.

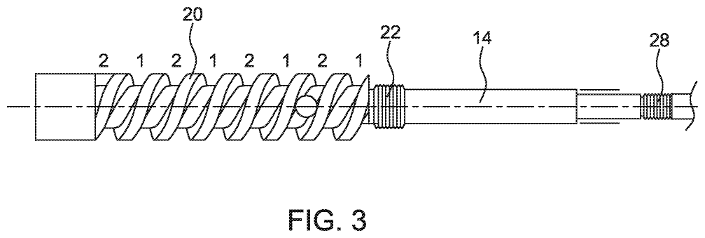

In some non-limiting embodiments or aspects, and with reference to FIG. 3, the stem 14 includes a first thread portion 20 and a second thread portion 22. The first thread portion 20 includes a first thread pitch at a double or three start rate. The first thread portion 20 interacts with and moves the actuation portion 18. The second thread portion 22 is in communication with a bonnet 24, which is attached to the valve body 12 and is in a substantially immovable relationship with the valve body 12. The second thread portion 22 also includes a second thread pitch or rate different from the first thread pitch or rate. The interaction between the second thread portion 22 and the bonnet 24 acts to move the stem 14 with respect to the body 12. In addition, the second thread pitch is smaller or “finer” than the first thread pitch 20. As will be discussed in more detail below, the differences in thread pitch between the first thread portion 20 and the second thread portion 22 facilitate the operation of the valve arrangement 10.

As shown in FIG. 2, in some non-limiting embodiments or aspects, the handle 16 is attached to the stem 14 using an attachment nut 26 which interacts with a third thread portion 28 (shown in FIG. 3). Using the attachment nut 26 and third thread portion 28, the handle 16 is rigidly, yet removably, attached to the stem 14, such that when the handle 16 is turned, the stem 14 is correspondingly rotated within the valve body 12.

In some non-limiting embodiments or aspects, and with reference to FIG. 2, the completed valve body 12 includes a first body half 30 and a second body half 32. Each body half 30, 32 includes a pipe portion 100, each of which is configured to be positioned around or fitted to a conduit portion or system (not shown). In addition, each body half 30, 32 is capable of being attached together by using a series of nuts and bolts or similar structural attachment mechanisms. It is contemplated that the body halves 30, 32 may also be welded together. When attached together, the first body half 30 and second body half 32 create a valve seat 39 below the pipe portions 100 into which the actuation portion 18 can extend. In addition, when attached together, the first body half 30 and second body half 32 create a sleeve or an opening in which the bonnet 24 is positioned or attached.

In some non-limiting embodiments or aspects, and with continued reference to FIG. 2, the actuation portion 18 may be in the form of a gate, which includes two discs 40 attached to a disc carrier block 42. The disc carrier block 42 includes a hollow interior defining an inner bore 58 for receiving the first thread portion 20 therein. The two discs 40 may be mild steel or stainless steel Belleville discs welded to the disc carrier block 42. It is also contemplated that two discs 40 may be made of other suitable materials known to a person having ordinary skill in the art. It is the discs 40 and disc carrier block 42 that create the actuation portion 18, which moves up and down with respect to the pipe portions 100 to place the valve arrangement 10 in the “open” or “closed” position. When in the “open” position, the actuation portion 18 is located vertically along the stem 14 so that the disc carrier block 42 and attached discs 40 are clear of the flow path within the pipe portions 100. When in the “closed” position, the disc carrier block 42 and discs 40 obstruct the flow path of fluids within the pipe portions 100. In particular, the discs 40 move up and down with respect to a pipe inner area 102 and extend at least partially into the valve seat 39 of the valve body 12.

In some non-limiting embodiments or aspects, the discs 40 may be angled, such that the distance between bottom portions 44 of each disc 40 is smaller than the distance between top portions 46 of each disc 40. In operation, this “angle” arrangement allows for a better clamping force as the actuation portion 18, the discs 40, and disc carrier block 42 are moved from the “open” position into the “closed” and seated position. As the actuation portion 18 is repetitively opened and closed, the friction fit between the discs 40 and the valve seat 39 becomes better and more conformal, thus providing a better seal.

Turning now to the first thread portion 20 and second thread portion 22, and with reference to FIGS. 2 and 3, the first thread portion 20 includes a first thread pitch that is much larger, coarser, and more angled than the second thread pitch of the second thread portion 22. In other words, the pitch of the second thread portion 22 is much finer relative to the first thread portion 20. This allows the stem 14 to advance slightly within the bonnet 24 while the disc carrier block 42, and thus the actuator portion 18, advances a much greater distance, as will be further discussed below. It is contemplated that the ratio of the pitch of the second thread portion 22 relative to the first thread portion 20 may be any amount to facilitate proper operation of the valve arrangement 10; however, ideally, the ratio between the pitches is between 2:1 and 3:1. The ratio between pitches may also change depending on the desired application of the valve arrangement 10 and how quickly or efficiently a user desires to move the actuation portion 18 from a fully closed to fully open position. It is the movement and turning of the handle 16 that rotates the stem 14 in concert with the first thread portion 20 and moves the actuation portion 18 up and down. In particular, through interaction between the disc carrier block 42, as will be discussed below, and the first thread portion 20, and due to the large pitch or angle of the first thread pitch, the disc carrier block 42, and thus the discs 40, can be quickly opened and closed.

In addition, in order to provide better coaction and easier and more efficient rotation, the first thread portion 20 of the stem 14 may be a “double-start” thread. This means that the thread portion 20 may have simultaneous helixes of equal rate winding down the stem 14, and these helixes are positioned 180 degrees with respect to each other, but on the same plane. As shown in FIG. 3, the simultaneous helixes are identified as numbers 1 and 2. Again, such an arrangement allows for easier coaction between the disc carrier block 42 and the first thread portion 20. Further, the use of this “double-start” thread arrangement maximizes the speed of the valve closure. It is also contemplated that a “triple-start” or other similar thread arrangement could be used on the stem 14 for transmitting additional power of the fine threads to provide closure functions and characteristics.

With continued reference to FIGS. 2 and 3, in some non-limiting embodiments or aspects, the second thread portion 22 is positioned above the first thread portion 20 on the stem 14, and the second thread portion 22 interacts with the bonnet 24. Specifically, the bonnet 24 includes a thread train 48 capable of interacting with the second thread portion 22 and second thread pitch. As the handle 16 is rotated and the stem 14 correspondingly rotated, the stem 14 moves in and out with respect to the valve body 12, due to the substantially rigid attachment of the bonnet 24 and the body 12. However, as best seen in FIG. 3, the second thread pitch of the second thread portion 22 is much finer, such that during the turning of the handle 16, and while the actuation portion 18 moves a great distance, the stem 14 moves only slightly. This “slight” movement is due to the differences in pitches and allows for the rapid and effective closing of the actuation portion 18 without a correspondingly large lateral movement of the stem 14 and handle 16. The much finer pitch of the second thread portion 22 provides the “power” and cinching that occurs during the final seating action, which will be discussed below. The finer pitch of the second thread portion 22 also ensures that, when turning the handle 16, the stem 14 only projects out of the valve body 12 at a minimal distance, which makes for safer operation of the valve arrangement 10.

As shown in FIG. 2, a bonnet nut 50 is attached around the stem 14 and winds over the bonnet 24 with respect to the valve body 12. In order to complement this seal, it is also envisioned that the bonnet 24 includes an O-ring groove (not shown) for accepting an O-ring 52 and a bonnet seat 56 for placement between the bonnet 24, O-ring 52, and bonnet nut 50. In some embodiments or aspects, the bonnet 24 is can be welded to the valve body 12. In addition, it is envisioned that various O-ring 52, or sealing arrangements can be obtained and used in order to clamp and seal between the bonnet 24 and the stem 14. A bonnet bushing 54 may also surround the stem 14 below the O-ring 52 thus providing an additional sealing element. This seal prevents effective movement of fluid material up the stem 14 during the winding process and prevents leakage in the system.

As discussed above, in some non-limiting embodiments or aspects, the discs 40 are attached to the disc carrier block 42. The discs 40 can be attached to the disc carrier block 42 using a variety of attachment mechanisms and techniques. In one embodiment, the disc carrier block 42 may include two opposing projections, which are configured to be at least partially inserted through corresponding orifices on each disc 40. Using a variety of techniques, such as welding or “button” welding, the discs 40 are rigidly attached to the disc carrier block 42 using the projections and a corresponding orifice.

In operation, the mating of the inner bore 58 and the first thread portion 20 moves the actuation portion 18 vertically along the stem 14. In order to move the valve assembly 10 into the “open” position, the handle 16 is turned in a first direction rotating the stem 14. The stem 14 moves in an upward direction only slightly because of the fine pitch of the second thread portion 22 received within the bonnet 24. While the second thread portion 22 limits the vertical movement of the stem 14 within the valve assembly 10, the much larger pitch of the first thread portion 20 permits the actuation portion 18, including the disc carrier block 42 and attached discs 40, to move upward a much larger distance along the stem 14. When the stem 14 is turned, the first thread portion 20 rotates within the inner bore 58 of the actuation portion 18. Due to the rotation of the stem 14 and the large value of the pitch of the first thread portion 20, the first thread portion 20 forces the actuation portion 18 upward as the first thread portion 20 rotates within the inner bore 58. Again, because of the larger value of the pitch of the first thread portion 20, the actuation portion 18 moves quickly relative to other valves between the “closed” position and “open” positions during rotation of the stem 14.

In some non-limiting embodiments or aspects, “double-start” and “triple-start” threads can be used in the example described above to facilitate quicker movement of the actuator portion 18 into the “open” position. The extra helices present with the “double-start” and “triple-start” threads allow the first thread portion 20 to provide the necessary upward force to the inner bore 58 of the actuation portion 18 in order to “open” the valve assembly more rapidly than would be possible otherwise. A mating thread train could be positioned or disposed on the wall of the inner bore 58 to help provide for more efficient raising and lowering of the actuation portion 18 as well. The mating thread train interacts with the first thread portion 20 so as to “climb” the first thread portion 20 when the actuation portion is moving to the “open” position. The mating thread train interacts with the helices of the first thread portion 20 as the first thread portion 20 rotates in order to move the actuation portion 18 upward along the first thread portion. As discussed above, a “double-start” or “triple-start” thread will allow the mating thread train to more quickly “climb” the first thread portion 20, allowing for a more rapid opening of the valve assembly 10.

In some non-limiting embodiments or aspects, the stem 14 still moves vertically some distance within the valve assembly 10 like a rising stem valve. As discussed above, the stem 14 only projects a small distance out of the valve body 12. However, due to the differences in pitches between the first 20 and second 22 thread portions, the actuation portion 18 rises vertically along the stem 14 like a non-rising stem valve. This example provides benefits of both the rising and non-rising stem valves in a single valve assembly 10.

When closing the valve assembly 10, the handle 16 is turned in a direction opposite the first direction in order to create the opposite effect. Namely, the actuator portion 18 moves down the first thread portion 20 and drives the discs 40 into the valve seat 39. The driving of the discs 40 into the valve seat 39 and helps prevent any back driving of the actuator portion 18 and ensures that the discs 40 remain properly seated in the seating portion 36. The fine threads on the second thread portion 22 provide the necessary locking features to the stem 14 which serve to prevent the back driving of the actuator portion 18. Proper seating of the discs 40 ensures that any over-the-road impacts and pump pressures do not accidentally open the valve assembly 10. Due to the finer pitch of the second thread portion 22, the driving of the discs 40 into the valve seat 39 will occur with the increased torque needed to properly seat the discs, but with relatively little force being provided by a user turning the handle 16. The larger pitch of the first thread portion 20 quickly moves the discs 40 downward into the valve seat 39 in a manner opposite to the way the discs were raised along the stem 14 as discussed above. This movement provides for a powerful sealing action or cinching at the end of the rapid motion provided by the disc carrier block 42 and together with the first 20 and second 22 thread portions. Such a final “seating” would not be possible with only the first thread portion 20, due to the first thread pitch and difficulty associated with additional movement of the handle 16.

In addition, in some non-limiting the number of turns of the handle 16 required to move from an “open” position to a “closed” position may be infinitely adjustable by adjusting the rate or pitch of the first thread portion 20 and/or the second thread portion 22, thus changing the ratio between the pitches as described above. For example, in one embodiment, the actuation portion 18 can go from a full open position to a completely closed position in 3½ turns of the handle 16. However, as discussed above, the number of turns of the handle 16 can be adjusted according to circumstance and application.

In this manner, the valve arrangement 10 uses the first thread portion 20 and second thread portion 22 to provide a quick-closing valve. Further, the present disclosure provides a valve arrangement 10 that effectively and forcefully “seats” the actuation portion 18 against the valve seat 39. During and after operation, the handle 16 and stem 14 do not project from the valve body 12 in an obtrusive position. Only a small extension of the stem 14 protrudes form the valve body 12 during operation of the valve arrangement 10. Such an arrangement also minimizes the possibility of foreign material being drawn into the seal area as the valve is closing. Still further, the present disclosure provides a valve arrangement 10 that is more compact and minimizes the possibility of stem 14 damage from contact, bending, etc.

It is to be understood that the disclosure may assume various alternative variations and step sequences, except where expressly specified to the contrary. It is also to be understood that the specific devices and processes illustrated in the attached drawings and described in the specification are simply exemplary embodiments or aspects of the disclosure. Although the disclosure has been described in detail for the purpose of illustration based on what are currently considered to be the most practical and preferred embodiments or aspects, it is to be understood that such detail is solely for that purpose and that the disclosure is not limited to the disclosed embodiments or aspects, but, on the contrary, is intended to cover modifications and equivalent arrangements that are within the spirit and scope thereof. For example, it is to be understood that the present disclosure contemplates that to the extent possible, one or more features of any embodiment or aspect can be combined with one or more features of any other embodiment or aspect.

1. A valve arrangement, comprising:
a valve body having a stem rotatably attached at least partially within the body;
a handle in operable communication with the stem and configured to rotate the stem by a turning movement; and
an actuation portion in contact with the stem and configured to move when the handle is turned and the stem rotated,
wherein the stem comprises a first thread portion having a first thread pitch and a second thread portion having a second thread pitch smaller than the first thread pitch,
wherein the actuation portion comprises a carrier having an inner bore and two discs mounted onto the carrier, wherein the inner bore is configured to receive at least a portion of the stem and the two steel discs are configured to block fluid flowing through a pipe,
wherein at least a portion of the first thread portion is configured to be at least partially received within the inner bore in order to interact with and move the carrier, and the second thread portion is configured to be at least partially received within a bonnet attached to the valve body and configured to move the stem with respect to the valve body.

2. The valve arrangement of claim 1, wherein the first thread portion comprises a double-start or triple-start thread.

3. The valve arrangement of claim 1, wherein a ratio of the second thread portion relative to the first thread portion is between 2:1 and 3:1.

4. The valve arrangement of claim 1, wherein the handle is attached to the stem with an attachment nut which interacts with a third thread portion of the stem.

5. The valve arrangement of claim 1, wherein each of the two discs is a Bellevile disc that is connected to the carrier.

6. The valve arrangement of claim 1, wherein the two discs are angled in opposite directions relative to the stem such that a distance between bottom portions of each disc is smaller than a distance between top portions of each disc.

7. The valve arrangement of claim 1, wherein the valve body comprises a first body half connected to a second body half.

8. The valve arrangement of claim 7, wherein each of the first body half and the second body half comprises a pipe portion.

9. The valve arrangement of claim 8, wherein the first body half and the second body half define a valve seat below the pipe portions, and wherein the valve seat is configured to receive at least a portion of the actuation portion.

10. The valve arrangement of claim 7, wherein the first body half and the second body half define a sleeve configured for receiving the bonnet.

11. The valve arrangement of claim 1, wherein the carrier comprises a hollow interior defining an inner bore configured for receiving the first thread portion.

12. A valve arrangement, comprising:
a valve body having a stem rotatably attached at least partially within the body;
a handle in operable communication with the stem and configured to rotate the stem by a turning movement; and
an actuation portion in contact with the stem and configured to move when the handle is turned and the stem rotated,
wherein the stem comprises a first thread portion having a first thread pitch and a second thread portion having a second thread pitch smaller than the first thread pitch.

13. The valve arrangement of claim 12, wherein the actuation portion comprises a carrier having an inner bore and two discs mounted onto the carrier, and wherein the inner bore is configured to receive at least a portion of the stem and the two steel discs are configured to block fluid flowing through a pipe.

14. The valve arrangement of claim 13, wherein at least a portion of the first thread portion is configured to be at least partially received within the inner bore in order to interact with and move the carrier, and the second thread portion is configured to be at least partially received within a bonnet attached to the valve body and configured to move the stem with respect to the valve body.

15. The valve arrangement of claim 12, wherein the first thread portion comprises a double-start or triple-start thread.

16. The valve arrangement of claim 12, wherein a ratio of the second thread portion relative to the first thread portion is between 2:1 and 3:1.

17. The valve arrangement of claim 12, wherein each of the two discs is a Bellevile disc that is connected to the carrier, and wherein the two discs are angled in opposite directions relative to the stem such that a distance between bottom portions of each disc is smaller than a distance between top portions of each disc.

18. The valve arrangement of claim 12, wherein the valve body comprises a first body half connected to a second body half, and wherein each of the first body half and the second body half comprises a pipe portion.

19. The valve arrangement of claim 18, wherein the first body half and the second body half define a valve seat below the pipe portions, and wherein the valve seat is configured to receive at least a portion of the actuation portion.

20. The valve arrangement of claim 18, wherein the first body half and the second body half define a sleeve configured for receiving the bonnet.
